(19) United States
(12) Patent Application Publication
(10) Pub. No.: US 2026/0016440 A1
(43) Pub. Date: Jan. 15, 2026

(54) BOBBLE STAT

(71) Applicants: University of Maryland, College Park, College Park, MD (US); William Marsh Rice University, Houston, TX (US); Government of the United States of America, as represented by the Secretary of Commerce, 1401 Constitution Avenue, NW, DC (US); The Government of the United States as represented by the Director, National Security Agency, Fort George G. Meade, MD (US)

(72) Inventors: John Robertson Rzasa, University Park, MD (US); Quinton Burke, Fallston, MD (US); Jason Chen, Towson, MD (US); Chen-Yu Chen, Beltsville, MD (US); William E. Bentley, Annapolis, MD (US); Gregory F. Payne, Hunt Valley, MD (US); Reza Ghodssi, Potomac, MD (US)

(21) Appl. No.: 19/266,695

(22) Filed: Jul. 11, 2025

Related U.S. Application Data
(60) Provisional application No. 63/670,349, filed on Jul. 12, 2024.

(51) Int. Cl. G01N 27/327; G01N 27/30

(52) U.S. Cl. CPC G01N 27/3277; G01N 27/301

(57) ABSTRACT

In accordance with the present disclosure, a method for autonomous biological sensing and actuation, includes: placing a printed circuit board (PCB) unit comprising a power controller board, microcontroller board, potentiostat board, and a power source, inside a watertight housing; connecting an electrode sensor to the potentiostat board and securing the electrode sensor to the watertight housing, the electrode sensor comprising a working electrode configured to be exposed to an external environment; sealing the watertight housing to enclose the PCB unit and power source while maintaining exposure of the working electrode to the external environment; immersing the sealed watertight housing into a thiolated hydrogel solution; applying an oxidative potential to the working electrode to initiate electrodeposition of a hydrogel matrix onto the working electrode surface; analyzing electrochemical data acquired from the electrode sensor through autonomous firmware; and applying an actuation signal to the working electrode based on the analyzed electrochemical data.

### CROSS-REFERENCE TO RELATED APPLICATION AND CLAIM OF PRIORITY

This application claims the benefit of, and priority to, U.S. Provisional Patent Application No. 63/670,349, filed on Jul. 12, 2024, the entire contents of which are hereby incorporated herein by reference.

### GOVERNMENT LICENSE RIGHTS

This invention was made with government support under HDTRA1-19-1-0021 awarded by the Defense Threat Reduction Agency and under MCB2227598 awarded by the National Science Foundation. The government has certain rights in the invention.

### TECHNICAL FIELD

The present disclosure relates generally to the field of electrochemical sensing and biological actuation systems. More specifically, the present disclosure provides systems, devices, and methods for self-contained, battery-powered, and wirelessly charged potentiostats capable of performing autonomous electrochemical routines and actuating engineered cells in fluid environments.

### BACKGROUND

Advances in synthetic biology and bioelectrochemistry have enabled new modes of interaction between biological systems and electronic interfaces. Among these, electrogenetics, which is the use of electrical signals to control gene expression in engineered cells, has emerged as a promising tool for dynamic and programmable biomanufacturing. However, the implementation of such systems in real-world environments is limited by the lack of flexible, autonomous platforms that are capable of both sensing environmental conditions and actuating biological responses.

Conventional potentiostats are often bulky, tethered, and not designed for immersion or standalone use. These constraints reduce their utility in distributed sensing or embedded bioreactor systems, where compactness, wireless control, and durability are essential. Many existing systems also lack real-time actuation capabilities, preventing them from closing the loop between sensing and response. In addition, a fabrication gap may limit development. This gap stems from differences between biological systems, which are made of delicate and self-correcting materials, and electronic devices, which are built from rigid and potentially harmful components that rely on strict error prevention and byproduct exclusion.

Therefore, there remains a need for compact, sealed, wirelessly powered and programmable systems that can operate autonomously in liquid environments, perform in situ electrochemical measurements, and actuate engineered cells based on local sensing, with support for modular components and remote data transmission.

### SUMMARY

In accordance with the present disclosure, a method for autonomous biological sensing and actuation, includes: placing a printed circuit board (PCB) unit comprising a power controller board, microcontroller board, a potentiostat board, and a power source, inside a watertight housing; connecting an electrode sensor to the potentiostat board and securing the electrode sensor to the watertight housing, the electrode sensor comprising a working electrode configured to be exposed to an external environment; sealing the watertight housing to enclose the PCB unit and power source while maintaining exposure of the working electrode to the external environment; immersing the sealed watertight housing into a thiolated hydrogel solution; applying an oxidative potential to the working electrode to initiate electrodeposition of a hydrogel matrix onto the working electrode surface; analyzing electrochemical data acquired from the electrode sensor through autonomous firmware executed by the microcontroller board; and applying an actuation signal to the working electrode based on the analyzed electrochemical data.

In an aspect of the present disclosure, the thiolated hydrogel solution may include thiolated polyethylene glycol (PEG-SH) and a redox mediator selected from ferrocene, ferrocene dimethanol, or mixtures thereof.

In an aspect of the present disclosure, the method may further include entrapping genetically engineered cells within the hydrogel matrix formed on the working electrode.

In an aspect of the present disclosure, the oxidative potential applied to the working electrode may be between a first positive voltage and a second positive voltge versus a silver/silver chloride reference electrode.

In an aspect of the present disclosure, a reductive potential may be applied to the working electrode to generate hydrogen peroxide for triggering a biological response in the genetically engineered cells.

In an aspect of the present disclosure, the biological response may include activation of an electrogenetic circuit configured to express a protein, signaling molecule, or metabolite.

In an aspect of the present disclosure, the autonomous firmware may be configured to perform electrochemical measurements using one or more techniques selected from cyclic voltammetry (CV), chronoamperometry (CA), or differential pulse voltammetry (DPV).

In an aspect of the present disclosure, the autonomous firmware may dynamically adjust stimulation parameters based on real-time electrochemical signal analysis.

In an aspect of the present disclosure, the method may further include wirelessly transmitting electrochemical or actuation data to an external device via Bluetooth or sub-GHz radio communication.

In an aspect of the present disclosure, the watertight housing may be configured as a float-type device having an antenna oriented above a liquid surface during operation.

In an aspect of the present disclosure, the watertight housing may be configured as an immersion-type device adapted for free movement in stirred or confined liquid environments.

In accordance with the present disclosure, a system for biological sensing and actuation, including: a potentiostat circuit configured to perform electrochemical measurements using an electrode sensor comprising a working electrode, a counter electrode, and a reference electrode; a power controller configured to regulate power delivery to a processor and the potentiostat circuit, and to manage energy input from a wireless charging coil; a processor; and a memory, including instructions stored thereon, which when executed by the processor cause the system to: apply an oxidative potential to the working electrode to deposit a hydrogel matrix on the electrode surface; collect electrochemical measurements from the electrode sensor; and apply an actuation signal to the electrode sensor based on the electrochemical measurements; and a watertight housing configured to enclose the potentiostat circuit, power controller, processor, and memory, and to support coupling of the electrode sensor such that the working electrode remains exposed to the external environment.

In an aspect of the present disclosure, the hydrogel matrix may include thiolated polyethylene glycol (PEG-SH).

In an aspect of the present disclosure, the hydrogel matrix may include genetically engineered cells.

In an aspect of the present disclosure, the genetically engineered cells may be configured to respond to hydrogen peroxide (H₂O₂) as an electrogenetic trigger.

In an aspect of the present disclosure, the actuation signal may comprise reductive voltage applied to the working electrode to generate hydrogen peroxide in situ.

In an aspect of the present disclosure, the controller may further include a wireless communication module configured to transmit electrochemical data via Bluetooth or sub-GHz radio frequencies.

In an aspect of the present disclosure, the watertight housing may include: a first screw-on cap having a plurality of integrated pockets configured to receive a plurality of weights; and a second screw-on cap configured to engage with the first screw-on cap to secure the electrode sensor.

In an aspect of the present disclosure, placement of the plurality of weights may be adjustable to control the flotation orientation of the watertight housing in a fluid environment.

In an aspect of the present disclosure, the electrode sensor may be removably mounted to the watertight housing and electrically connected to the potentiostat via spring-loaded contacts.

In an aspect of the present disclosure, the system may be configured to operate autonomously based on onboard firmware without continuous external control.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 illustrates a watertight housing of a biological sensing and actuation system for an immersion-type PCB stack unit, in accordance with the present disclosure;

FIG. 2 illustrates the immersion-type PCB stack unit of FIG. 1, in accordance with the present disclosure;

FIG. 3 illustrates the power controller board of the immersion-type PCB stack unit of FIG. 2, in accordance with the present disclosure;

FIG. 4 illustrates the microcontroller board of the immersion-type PCB stack unit of FIG. 2, in accordance with the present disclosure;

FIG. 5 illustrates the potentiostat board of the immersion-type PCB stack unit of FIG. 2, in accordance with the present disclosure;

FIGS. 6A and 6B illustrates the electrode sensor of the biological sensing and actuation system, in accordance with the present disclosure;

FIG. 7 illustrates the float-type housing of the watertight housing component of the biological sensing and actuation system, in accordance with the present disclosure.

FIG. 8 illustrates the float-type PCB unit of the biological sensing and actuation system, in accordance with the present disclosure;

FIG. 9 illustrates an alternative embodiment of the electrode interface for the biological sensing and actuation system, in accordance with the present disclosure;

FIGS. 10A and 10B illustrates the mediated formation of an artificial biofilm using electro assembled hydrogel and engineered cells, in accordance with the present disclosure;

FIG. 11 demonstrates a representative example of this platform using a strain of engineered Escherichia coli (E. coli), in accordance with the present disclosure; and

FIG. 12 is a flowchart of an exemplary method for implementing the biological sensing and actuation system, in accordance with the present disclosure.

### DETAILED DESCRIPTION

The present disclosure relates generally to the field of electrochemical sensing and actuation. More specifically, the present disclosure relates to systems and methods for autonomous, self-contained, and wirelessly controlled potentiostat that perform electrochemical measurements and actuate engineered biological cells in fluid environments.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Conventional electrochemical sensing platforms are limited by bulkiness, tethered configurations, and lack of integration with biological actuation systems, making them unsuitable for autonomous operation in fluid environments such as bioreactors, natural water bodies, or distributed biosensing networks. These limitations are exacerbated by the mismatch between rigid electronic hardware and delicate biological systems, which require both gentle interfacing and dynamic responsiveness to environmental changes. The present disclosure addresses this technical problem by providing a compact, sealed, and wirelessly powered system that integrates a three-electrode potentiostat, autonomous firmware, and genetically engineered biological payloads within a modular housing. The system is configured to perform real-time electrochemical sensing, interpret environmental signals via onboard data processing, and initiate biologically meaningful outputs such as gene expression through programmable electrogenetic actuation. This architecture enables fully autonomous, closed-loop operation without continuous human oversight or hardwired infrastructure.

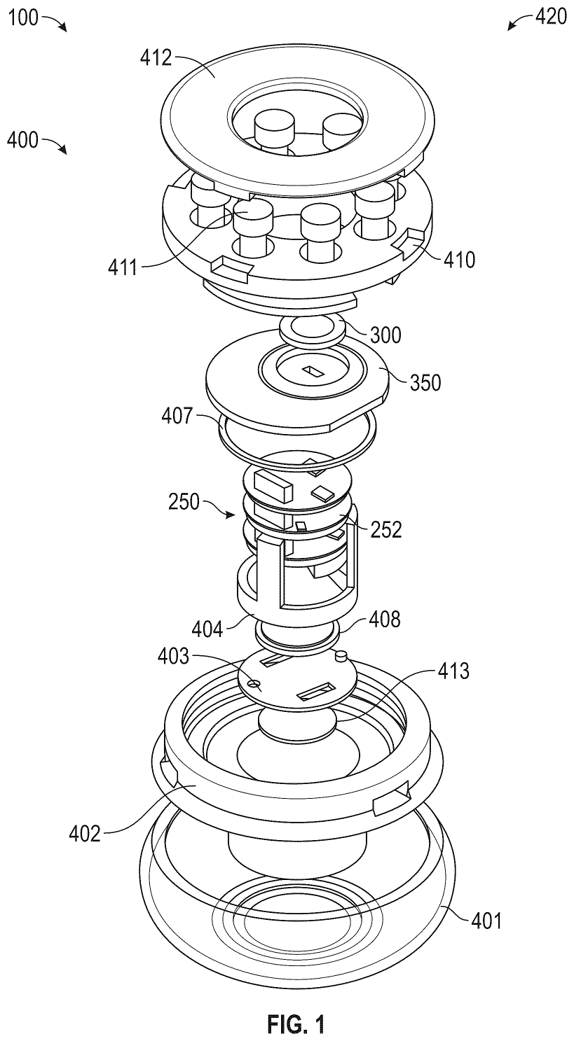

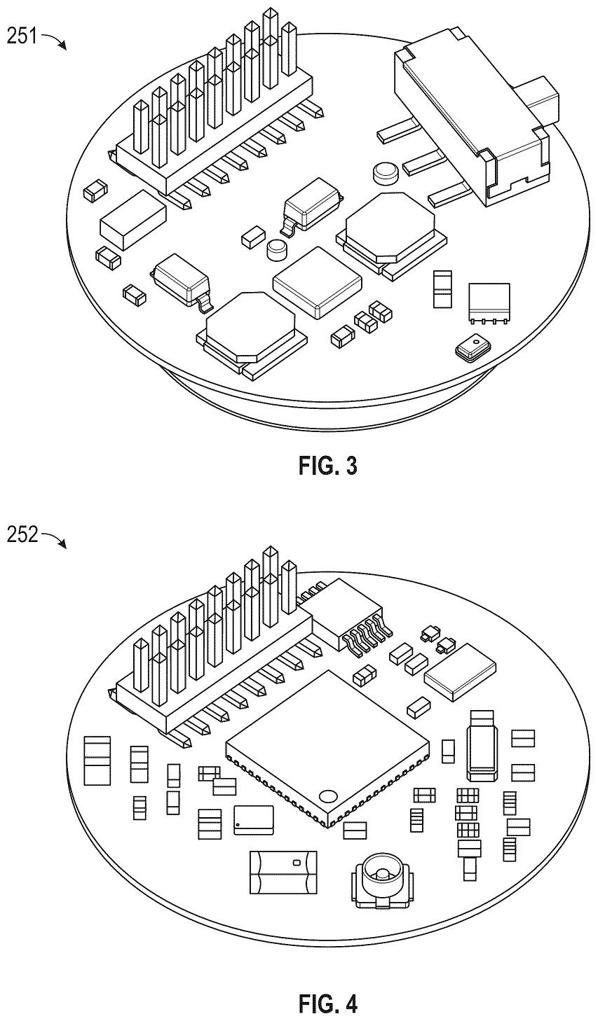

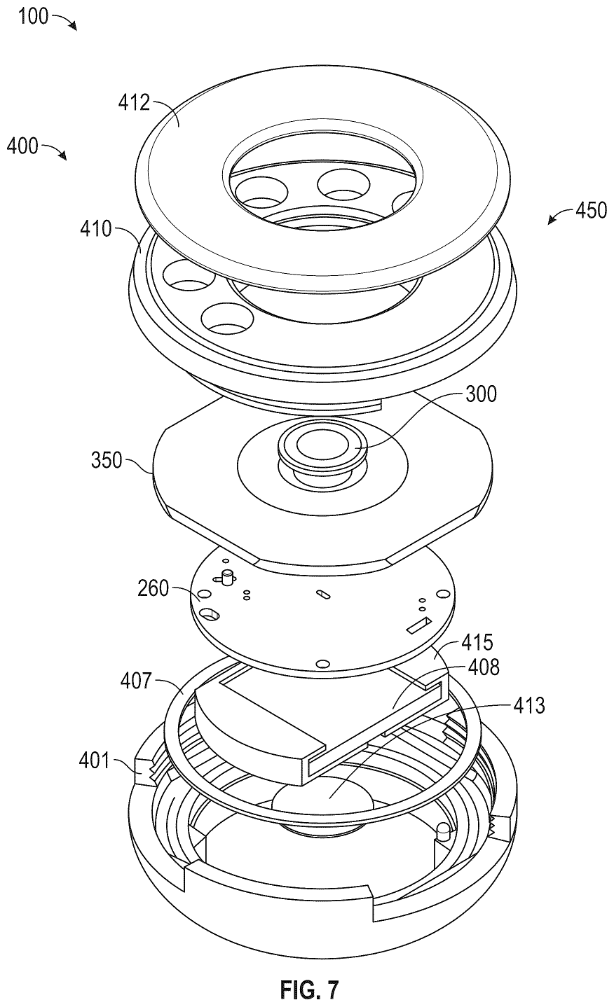

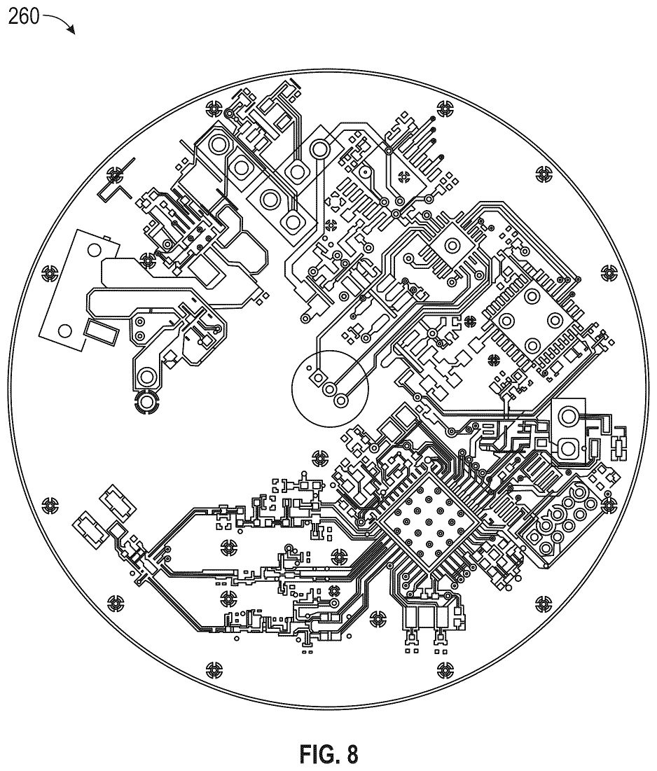

Referring to FIG. 1, the present disclosure is directed to a biological sensing and actuation system 100. The biological sensing and actuation system 100 includes a printed circuit board (PCB) unit 200, an electrode sensor 300, and a watertight housing 400. The PBC unit 200 may be configured as an immersion-type PCB unit 250 (FIG. 3) or as a float-type PBC unit 290 (FIG. 8). The watertight housing may be configured as an immersion type housing 420 (FIG. 1) or as a float-type housing (FIG. 7).

FIG. 1 illustrates the watertight housing 400 of the biological sensing and actuation system 100 for the immersion-type PCB stack unit 250. The immersion-type housing 420 includes a main frame 401, a main frame inner cavity 402, a PCB scaffold 405, the immersion-type PCB stack unit 250, an electrode substrate 350, an o-ring 407, a rechargeable battery 408, the electrode sensor 300, a first screw-on cap 410, weights 411, a second screw-on cap 412, and a battery charging coil 413. PCB stack unit 250 may include a controller. The controller may include a processor and a memory, that includes instructions to operate the biological sensing and actuation system 100.

The biological sensing and actuation system 100 further comprises an autonomous control architecture that enables fully self-directed measurement, analysis, and actuation without the need for continuous user input or external communication. In some embodiments, the device performs potentiostat routines including, but not limited to, cyclic voltammetry (CV), chronoamperometry (CA), differential pulse voltammetry (DPV), and other custom waveforms. These routines are executed by an onboard microcontroller that interprets electrochemical signals acquired through a three-electrode sensor immersed in the local environment. This functionality allows the system to dynamically assess molecular cues and redox states in situ using mediated electrochemical probing.

Upon detecting predefined environmental signatures, such as the presence of specific chemicals, ions, or microbial activity, the biological sensing and actuation system 100 may initiate programmed actuation sequences. These actuation signals are delivered to electroassembled engineered cells immobilized on the electrode surface within a PEG-based hydrogel matrix. The cells contain genetic circuits designed to respond to electrical stimuli via electrogenetic mechanisms. Depending on the configuration, these circuits can drive the production of bioactive compounds, such as pharmaceuticals, metabolic intermediates, or microbial signaling molecules. In some embodiments, the system may transmit electrical signals that generate localized concentrations of hydrogen peroxide (H₂O₂), which function as intracellular inducers in the engineered cell populations.

The decision-making process employed by the device is governed by adaptive firmware that evaluates real-time electrochemical feedback and autonomously determines subsequent measurement or stimulation parameters. For example, the microcontroller board 252 or the float-type PCB unit 260 may sweep through a range of voltages, monitor resulting current responses, and iteratively adjust the waveform to identify an optimal stimulation condition, such as a redox peak or inflection point. Once a threshold is met, the biological sensing and actuation system 100 may execute an actuation protocol tailored to the detected input. This looped sensing-decision-response workflow can be repeated over extended durations, enabling the device to operate continuously and responsively within fluid environments.

This autonomous functionality is particularly advantageous in field deployments, such as in rivers, lakes, coastal zones, or other inaccessible locations, where maintaining a persistent communication link is impractical. In these scenarios, the biological sensing and actuation system 100 conserves power through firmware-level sleep cycles and only activates high-power operations as required by internal decision logic. Wireless updates and configurations may be pushed during proximity-based communication windows, such as when the device is retrieved or contacted via drone flyover.

By integrating potentiostatic measurement, onboard data analysis, and programmable biological output into a sealed, self-powered platform, the biological sensing and actuation system 100 establishes a fully autonomous bioelectronic interface. This capability supports a wide range of applications, from distributed environmental sensing to closed-loop biomanufacturing, wherein engineered microbial functions can be initiated, modulated, and terminated by electronic cues, all without human intervention.

The main frame 401 defines the external enclosure of the immersion-type housing 420 and is configured to house the internal components of the biological sensing and actuation system 100. The inner cavity 402 is defined within the main frame 401 and houses the PCB scaffold 405, which includes a scaffold bottom 403 and scaffold top 404. The scaffold 405 is configured to support and protect the immersion-type PCB unit 250 during operation and handling. The electrode substrate 350 is mounted at the upper portion of the housing 420 and provides an electrical interface to the electrode sensor 300. On the reverse side of the electrode sensor 300, three contact pads are arranged to precisely align with spring-loaded pogo pins on the potentiostat board 253, enabling secure electrical connection without the need for soldering or adhesives. The O-ring 407 is seated in a recessed groove of the main frame 401 and, when compressed by the first screw-on cap 410, forms a watertight seal to prevent fluid ingress. The second screw-on cap 412 is configured to lock onto the first screw-on cap 410 and acts as a lid, providing structural reinforcement and access control to the internal electrode interface. The electrode substrate 350 is clamped between the first screw-on cap 410 and the second screw-on cap 412 and the body of the immersion-type housing 420, ensuring positional alignment and sealing against fluid ingress.

The rechargeable battery 408 is positioned within the scaffold and aligned above the battery charging coil 413, which is located at the base of the housing to enable wireless inductive charging through the polymer shell. The first screw-on cap 410 and second screw-on cap 412 are configured with integrated pockets for receiving a plurality of weights 411. The location and distribution of the weights 411 are adjustable to control the depth, orientation, and stability of the system 100 in fluid environments. In some embodiments, vent gaps are integrated into the threads of the first screw-on cap 410 to permit the escape of trapped air bubbles during submersion, thereby ensuring consistent sensor exposure and functionality.

The immersion-type housing 420 is manufactured using clear, flexible resin via stereolithographic 3D printing, which provides impact resistance and allows visual inspection of internal status indicators such as light-emitting diodes (LEDs). In alternative embodiments, the housing may be fabricated using injection-molded components and inert plastics for increased scalability and chemical compatibility. The compact, pill-shaped configuration is optimized for submersion in confined liquid environments such as stirred bioreactors. The flexible housing reduces mechanical strain and allows system 100 to circulate freely without interfering with impellers or vessel walls. The Bluetooth-enabled communication module supports short-range data transmission, and the system can be wirelessly configured or monitored. The modular, vertically stacked PCB architecture supports customizable sensing and actuation routines, enabling integration with a variety of sensors, hydrogels, and biological payloads.

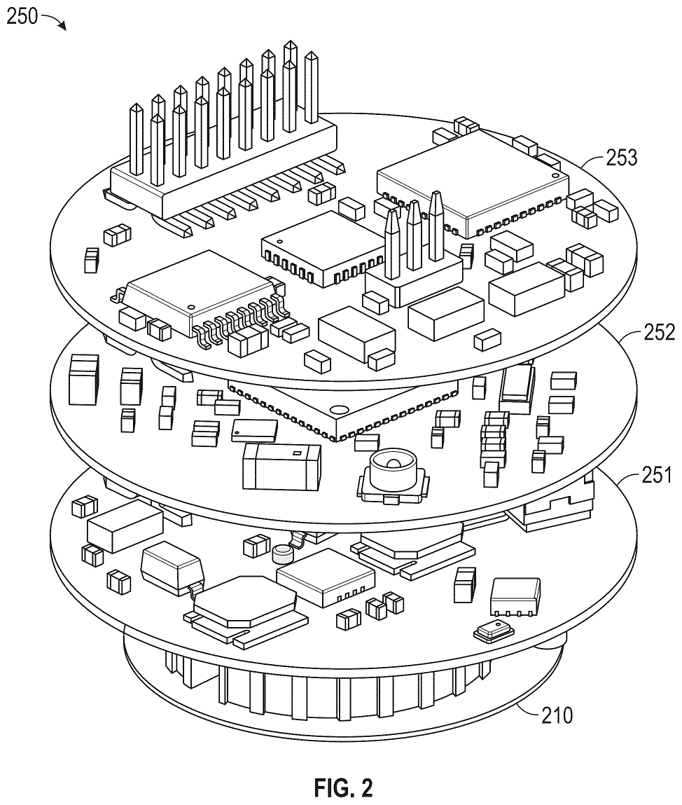

FIG. 2 illustrates the immersion-type PCB stack unit 250 configured for use within the immersion-type housing 420. The immersion-type PCB stack unit 250 includes, from bottom to top, a wireless charging board 210, a power controller board 251, a Bluetooth microcontroller board 252, and a potentiostat board 253. The boards of the immersion-type PCB stack unit 250 are mechanically and electrically connected via vertical pin headers, enabling efficient power and signal transmission in a compact vertical configuration. The potentiostat board 253 is positioned atop the microcontroller board 252, which is stacked above the power controller board 251, and the wireless charging board 210 forms the base of the stack. This configuration of the immersion-type PCB stack unit 250 is designed to maximize spatial efficiency while maintaining modularity. In some embodiments, one or more of the individual boards may be substituted or reconfigured to accommodate application-specific requirements such as alternate sensors, expanded memory, or different wireless modules. The combined functionality of the PCB stack unit 250 supports wireless charging, onboard data processing, and electrochemical sensing, forming the core operational platform of the biological sensing and actuation system 100.

FIG. 3 illustrates the power controller board 251 of the immersion-type PCB stack unit 250. The power controller board 251 interfaces with the wireless charging board 210, which is located beneath it in the stack. The power controller board 251 includes a rechargeable lithium-ion battery, an inductive charging coil, a charge controller, and one or more regulated power supplies for providing power to the microcontroller board 252 and potentiostat board 253. Wireless charging is facilitated through the polymer housing of the device by aligning the charging coil with a cradle-based inductive transmitter. The standard battery configuration is rated at approximately 500 mAh, enabling autonomous device operation for multiple days, including intermittent signal transmission, hydrogel formation, and electrogenetic actuation. In some embodiments, the inductive charging coil may be mounted on the underside of the power controller board 251 or integrated directly into the watertight housing 400. In alternative embodiments, additional batteries may be added in parallel to extend operation time. The power controller board 251 may further include protective circuitry, such as thermal shutdown, overcurrent protection, and voltage regulation, to ensure safe operation in submerged environments. The inductive charging interface may support multiple frequency bands to allow compatibility with different types of external wireless charging platforms.

FIG. 4 illustrates the microcontroller board 252 of the immersion-type PCB stack unit 250. The microcontroller board 252 includes a wireless-enabled processor, such as a Texas Instruments CC1352 Bluetooth microcontroller, although other processors may be used depending on application needs. The processor integrates a floating-point unit, a BLE5 protocol stack for short-range wireless communication, and a 900 MHz transceiver for long-range transmission. Autonomous firmware is stored on and executed by microcontroller board 252. The autonomous firmware is responsible for running potentiostat board 253 routines, executing electrogenetic actuation, and making environmental decisions. The autonomous firmware stored on the microcontroller controls the potentiostat board 253 based on predefined measurement routines and real-time data received from the electrode sensor 300, including signals generated by immobilized engineered cells.

The microcontroller board 252 executes the system-level autonomous firmware responsible for orchestrating electrochemical sensing routines, initiating electrogenetic actuation, logging data, and managing system power states. In the event that a Bluetooth signal cannot reach a remote receiver, such as during environmental monitoring in rivers or lakes, the device may transmit data via a 900 MHz antenna to aerial drones or intermediate ground-based receivers. The microcontroller board 252 includes non-volatile flash memory for long-term data storage, enabling the device to retain measurements, configuration states, and event logs until physical recovery or remote communication is established. Power efficiency is achieved through firmware-based sleep cycles, in which peripheral subsystems are powered down between sensing intervals. A chip antenna is used for BLE5 operation, while a whip antenna is used for long-range 900 MHz communication, both of which may be routed through the housing for optimal signal propagation. The radio frequency protocol is software-selectable, allowing either BLE5 or a custom 900 MHz stack to operate on the same PCB hardware without modification, enabling flexible deployment in both short-range and long-range configurations. The microcontroller board 252 supports over-the-air (OTA) firmware updates, allowing post-deployment configuration and feature enhancement. In some embodiments, the processor may perform onboard signal analysis and adaptive control using edge computing techniques, enabling autonomous decision-making based on detected environmental conditions. In some embodiments, the system may be configured and queried by a smartphone application or remote host processor, which communicates with the microcontroller to retrieve stored data and modify operational settings.

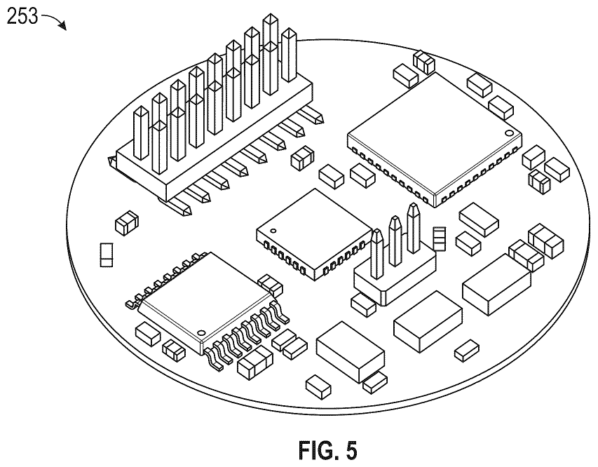

FIG. 5 illustrates the potentiostat board 253 of the immersion-type PCB stack unit 250. The potentiostat board 253 includes a 24-bit analog-to-digital converter (ADC), a 16-bit digital-to-analog converter (DAC), one or more analog integrated circuit switches, and multiple operational amplifiers configured to implement a full three-electrode potentiostat system. This includes control and measurement of a counter electrode, reference electrode, and working electrode. The DAC generates a programmable voltage applied to the counter electrode, while the operational amplifiers adjust and stabilize the potential with respect to the reference electrode. The resulting current at the working electrode is converted to a proportional voltage by a transimpedance amplifier and subsequently digitized by the ADC for analysis by the microcontroller board 252. The potentiostat board 253 operates under the control of the firmware running on the microcontroller and does not itself store or execute any firmware routines. In the present embodiment, the potentiostat board 253 includes a digitally controlled analog switch that allows for the complete disconnection of all three electrodes of the electrode sensor 300, enabling an electrically floating state to prevent unwanted electrochemical reactions during passive monitoring or sleep states. The potentiostat board 253 is positioned at the top of the immersion-type PCB stack unit 250 and may include a debug header or diagnostic interface to facilitate testing and firmware development. In some embodiments, the potentiostat board 253 is capable of executing a range of waveform routines, including cyclic voltammetry (CV), chronoamperometry (CA), and differential pulse voltammetry (DPV). Additionally, the analog front-end circuitry may support signal multiplexing to enable the use of multiple electrode sets or sensing channels during a single deployment. In some embodiments, the potentiostat circuitry supports arbitrary waveform generation, including user-defined or adaptive sequences that sweep across multiple configurations in response to prior measurement results.

In addition to measurement routines, the potentiostat board 253 is configured to deliver actuation signals under control of the microcontroller firmware. These actuation signals may include single-voltage steps, programmed waveforms, or sustained polarizations intended to initiate electrogenic activity in immobilized cells. Such signals are applied in response to real-time interpretation of measurement data, including current profiles, redox activity thresholds, or time-averaged analyte concentration metrics

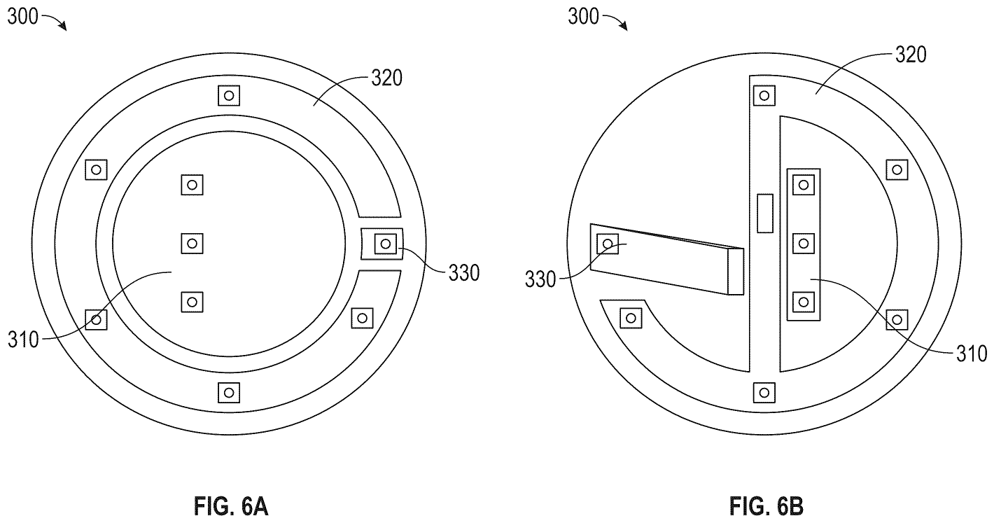

FIGS. 6A and 6B illustrates the electrode sensor 300 of the biological sensing and actuation system 100. Th electrode sensor 300 is configured in a circular three-electrode layout and includes a working electrode 310, a counter electrode 320, and a reference electrode 330. The working electrode 310 is centrally located, the counter electrode 320 is formed as an annular ring surrounding the working electrode 310, and the reference electrode 330 is positioned as an offset region adjacent to the working electrode 310. Although circular in shape for compatibility with the compact housing geometry and uniform electrochemical fields, other suitable geometries may be used depending on application-specific design constraints or fluid dynamics requirements. The electrode sensor 300 makes an electrical connection to the makes an electrical connection to the potentiostat board 253 via spring-loaded pogo pins that align with gold contact pads. In an alternative embodiment, illustrated in FIG. 6B, the electrode sensor 300 may be geometrically organized such that the working electrode 310 and counter electrode 320 are shaped as spatially separated conductive regions that follow a semicircular or arc-shaped pattern, while the reference electrode 330 is embedded along a discrete conductive trace between them. This layout minimizes electrical crosstalk and allows for enhanced control over the electrochemical field distribution, which may be advantageous for certain analytical modes or fluidic flow conditions.

The working electrode 310 and counter electrodes 320 are composed of gold deposited via sequential electroless plating. The reference electrode 330 is fabricated using a silver layer that is chlorinated to produce a silver/silver chloride surface. In alternative embodiments, the electrode materials may be substituted with platinum, carbon, or other conductive or electrochemically stable materials tailored to different sensing environments or chemical compatibilities. The electrode sensor 300 is fabricated using a series of surface treatments including electrocleaning, electro-activation, and metal deposition, ensuring both high-performance signal transduction and material stability. The electrode sensor 300 is mounted on an electrode substrate 350, which serves as a mechanical interface, alignment guide, and sealing surface. The electrode sensor 300 is adhered to the electrode substrate 350 to ensure proper alignment and waterproofing. The electrode sensor 300 is connected to the potentiostat board 253 via pogo pins that align with the electrode's gold contact pads, providing a secure, solder-free electrical interface. The electrode substrate 350 is constructed from a dielectric material and is shaped to seat the electrode securely within the first screw-on cap 410 and second screw-on cap 412 of the watertight housing 400. When assembled, the electrode substrate 350 is compressed against the O-ring 407 to establish a fluid-tight seal, isolating internal electronics from the external liquid while leaving the active electrode area exposed for sensing and actuation (see e.g., FIG. 1).

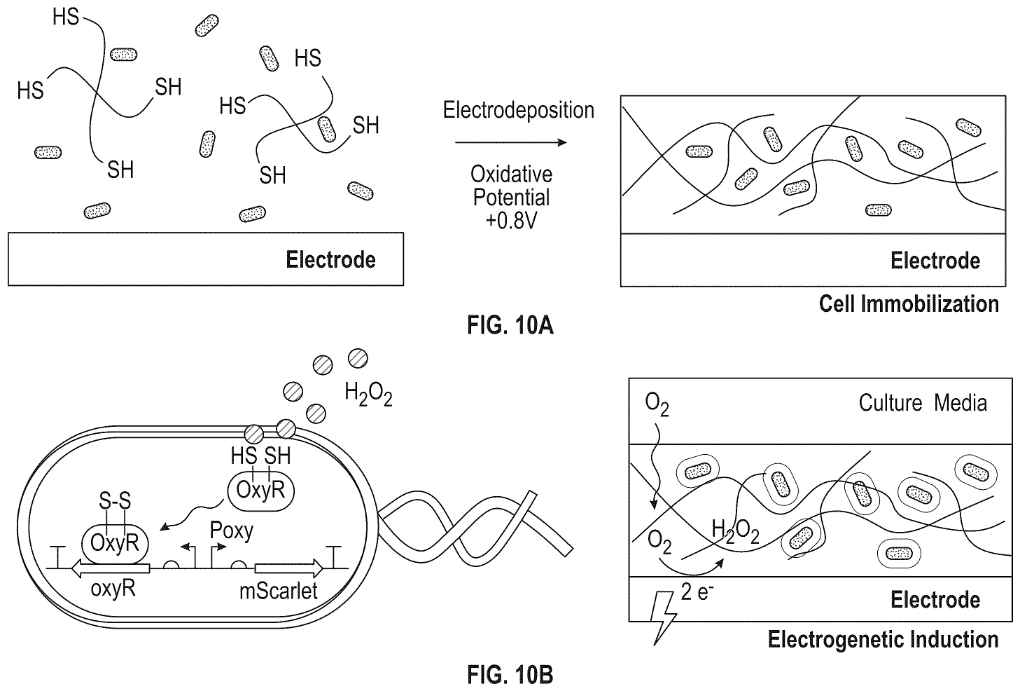

In certain embodiments, a functionalized hydrogel is electrochemically assembled directly onto the surface of the working electrode 310 (see e.g., FIG. 10). This hydrogel is formed from a thiolated polyethylene glycol (PEG-SH) solution containing a redox mediator and engineered biological cells. Upon application of an oxidizing potential, the PEG-SH crosslinks into a stable hydrogel network, entrapping the engineered cells at the electrode interface. The hydrogel-localized cells may then be stimulated via electrogenetic inputs, such as a reductive potential that generates hydrogen peroxide, enabling precise electronic control of gene expression or metabolic output.

In some embodiments, the electrode sensor 300 is configured to be replaceable or modular, facilitating maintenance, cleaning, or adaptation to different sensing tasks. Additional sealing components such as gaskets, conformal coatings, or molded elastomers may be incorporated to enhance water resistance and operational durability in harsh environments.

FIG. 7 illustrates the float-type housing 450 of the watertight housing 400 component of the biological sensing and actuation system 100. The float-type housing 450 includes a main frame 401, a float-type PCB unit 260, an electrode substrate 350, an O-ring 407, a rechargeable battery 408, the electrode sensor 300, a first screw-on cap 410, a second screw-on cap 412, a battery scaffold 415, and a battery charging coil 413.

The main frame 401 defines the outer shell of the float-type housing 450 and encloses both the electronic subsystems and the buoyancy control components. The float-type PCB unit 260, which integrates the microcontroller, power regulation, and potentiostat circuits onto a single board, is securely installed within the main frame 401. The rechargeable battery 408 is positioned adjacent to the float-type PCB unit 260 and is mechanically stabilized by a dedicated battery scaffold 415, which prevents displacement during field deployment or mechanical agitation. The battery charging coil 413 is mounted along the inner surface of the base of the main frame 401, permitting inductive charging through the polymer housing without the need for external ports or connectors.

The electrode sensor 300 is mounted to an electrode substrate 350, which serves as a rigid dielectric platform for aligning and sealing the sensor into the first screw-on cap 410 and second screw-on cap 412 of the float-type housing 450. As shown in FIG. 7, the electrode sensor 300 and electrode substrate 350 are the same components described above with respect to FIGS. 1 and 6A-6B and are reused here within the float-type configuration. The electrode substrate 350 is seated flush against an O-ring 407 embedded in a groove on the upper portion of the main frame 401. This assembly is compressed by the first screw-on cap 410, forming a water-tight seal that isolates the electronics while leaving the electrode surface exposed for environmental contact. A second screw-on cap 412 interlocks with the first screw-on cap 410, providing additional structural reinforcement and secure retention of the electrode module. Integrated within both the first screw-on cap 410 and second screw-on cap 412 are weight pockets 416, which are configured to receive and secure one or more discrete weights 411 (see e.g., FIG. 1). The quantity and distribution of these weights are adjustable to control the floating orientation of the device. In an unweighted configuration, the float-type housing 450 remains level and floats on the water surface. When weights are selectively added to one side of the first screw-on cap 410, the float-type housing 450 reorients configuration, causing the electrode substrate 350 and sensor 300 to submerge while the opposite side, the wireless antenna, located on the float-type PCB unit 260, is maintained above the waterline to support unhindered signal transmission. In some embodiments, the antenna supports 900 MHz operation with a communication range of up to 1,000 feet.

The housing 450 is constructed from a clear resin via stereolithographic 3D printing, allowing for visual inspection of internal LED indicators or status elements. In other embodiments, injection molding using inert thermoplastics may be employed for cost-effective mass production. The float-type housing 450 is intended to operate autonomously in outdoor or distributed water monitoring networks and is ideally suited for drone-assisted data retrieval and configuration.

FIG. 8 illustrates the float-type PCB unit 260 of the biological sensing and actuation system 100. The float-type PCB unit 260 is a circular, monolithic printed circuit board that integrates all core subsystems, including power regulation, wireless communication, microcontroller control logic, and potentiostat functionality, into a single cohesive layout. The float-type PCB unit 260 consolidates all functional circuitry onto a single board and includes a low-power microcontroller with onboard Bluetooth Low Energy (BLE5) capability for short-range communication, as well as a 900 MHz radio transceiver for long-range connectivity. The radio frequency protocol is software-selectable, allowing either BLE5 or a custom 900 MHz stack to operate on the same PCB hardware without modification, enabling flexible deployment in both short-range and long-range configurations. These communication modalities are enabled through dedicated chip and whip antennas mounted directly to the board, allowing flexible configuration based on deployment distance or infrastructure availability. The dual-mode radio design is particularly useful in remote settings where direct line-of-sight communication with ground stations or low-flying drones may be intermittently available.

The float-type PCB unit 260 contains a wireless-enabled processor that executes the autonomous firmware of the system. This firmware governs potentiostat routines, performs signal analysis, initiates actuation of engineered cells, and makes real-time decisions based on electrochemical feedback. The consolidated design of the float-type PCB unit 260 allows the firmware to interact directly with the integrated analog front end and power subsystems without inter-board latency or connector limitations. The firmware is stored on the microcontroller portion of the float-type PCB unit 260 and enables both fully autonomous operation and remote reconfiguration. In some embodiments, the firmware also manages data logging, power state transitions, and OTA (over-the-air) updates. In some embodiments, the system may be configured and queried by a smartphone application or remote host processor, which communicates with the microcontroller to retrieve stored data and modify operational settings.”

The float-type PCB unit 260 further includes a 24-bit analog-to-digital converter (ADC), a 16-bit digital-to-analog converter (DAC), multiple operational amplifiers, RF filters, and an analog switch network. Together, these components implement a full-featured three-electrode potentiostat capable of executing cyclic voltammetry (CV), chronoamperometry (CA), differential pulse voltammetry (DPV), and other waveform routines. The analog front end may be configured for high-precision sensing, multi-electrode routing, or baseline current suppression depending on firmware instructions. Voltage regulators and power distribution networks are embedded into the float-type PCB unit 260, with careful attention to thermal isolation and electromagnetic compatibility. This unified architecture streamlines device assembly and enhances mechanical robustness for operation in dynamic surface water environments. The circular geometric shape of the float-type PBC unit 260 is configured to be compatible with the geometric configuration of the float-type housing 450, ensuring proper alignment with buoyancy structures, sealing interfaces, and antenna placement.

The float-type PCB unit 260 is designed for use in open water environments such as lakes, rivers, and coastal regions, where sustained floatation, directional orientation, and long-range wireless communication are essential. In some embodiments, the float-type PCB includes auxiliary connectors to interface with additional sensors, alternative electrode modules, or telemetry accessories. Programmable indicator LEDs, debug headers, and onboard memory chips may also be integrated to support data logging, firmware updates, and post-deployment diagnostics.

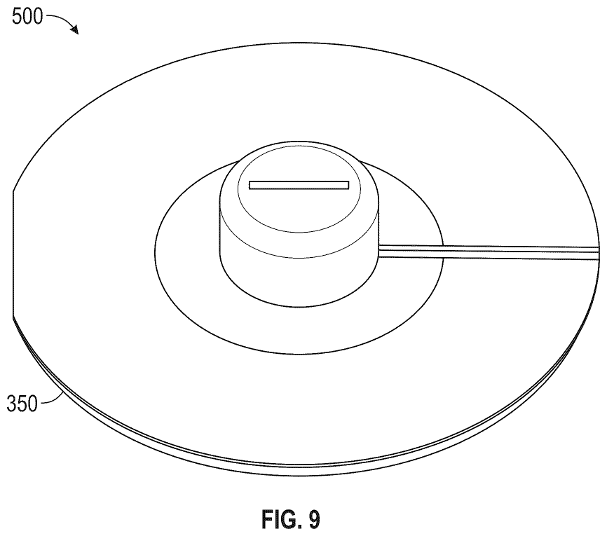

FIG. 9 illustrates an alternative embodiment of the electrode interface 500 for the biological sensing and actuation system 100. This embodiment replaces the circular electrode sensor 300 and substrate 350 configuration described in FIGS. 1 and 6A-6B with a modular interface designed to support off-the-shelf, screen-printed electrodes. In addition to the custom electrodes, the biological sensing and actuation system 100 can also be equipped to work with commercially available screen-printed electrodes. To accommodate these electrodes, an alternate electrode interface 500 is implemented. This electrode interface 500 may incorporate a standard off-the-shelf three-pin connector encased inside a protective housing that includes a silicone gasket to ensure water-tightness during submersion. Electrical connection to the system may be made through a 3-pin header, which replaces the pogo pin interface used in the other embodiment of the biological sensing and actuation system 100. Engineered cells can be loaded onto the electrode surfaces and triggered via specific electrical signals to produce a variety of biomolecular outputs. These outputs may include pharmaceuticals, metabolic intermediates, or signaling molecules that influence microbial community dynamics. This electrode system design supports both single-use and reusable operation modes and is compatible with remote firmware-driven configuration and actuation routines.

The electrode interface 500 includes an electrode substrate 350 which may be configured as a circular, planar component designed to align with the upper opening of the watertight housing 400 (FIG. 1). The substrate 350 may serve as a mounting platform for the electrode sensor 300 (FIG. 1) and may also function as a sealing interface between the external environment and the internal electronics. In some embodiments, the substrate 350 may include a recessed slot or channel to accommodate routing of an electrical lead or wire. This slot may allow the wire to pass from the electrode surface to the underlying electrical interface, such as a pogo pin array or 3-pin header, without interfering with sealing features or mechanical retention points.

The perimeter of the substrate 350 may be dimensioned to sit flush against a compressible sealing element, such as O-ring 407 (FIG. 1), which may be embedded within the main frame 401 (FIG. 1) of the housing. When assembled, the substrate 350 may be vertically compressed between the first screw-on cap 410 and the second screw-on cap 412, providing mechanical retention and forming a watertight seal. The circular geometry of the substrate 350 may offer uniform sealing pressure and facilitate ease of alignment during installation. In some embodiments, alignment features such as keyed notches or registration marks may be used to ensure correct orientation within the housing 420 or 450, depending on whether the system is configured in immersion-type or float-type format.

The electrode sensor 300 may be mounted on the upper face of the substrate 350 using adhesive bonding, mechanical retention features, or other attachment means. The bottom face of the substrate may interface with the potentiostat board 253 (FIG. 1) or the float-type PCB unit 260 via spring-loaded pogo pins or, in alternative embodiments, a 3-pin header. The wire connecting the electrode sensor 300 to the internal circuit may be routed through the recessed slot in the substrate 350, minimizing strain and preserving the integrity of the seal. This arrangement may support modularity, allow for quick replacement or reconfiguration of the electrode assembly, and ensure reliable electrical connection while maintaining fluid isolation.

FIG. 10 illustrates the mediated formation of an artificial biofilm using electro assembled hydrogel and engineered cells. A functionalized cell/polyethylene glycol (PEG)-based hydrogel can be formed directly on the working electrode 310 of the electrode sensor 300 (see e.g., FIGS. 6A and 6B) using a mediator-facilitated electrodeposition technique, which creates a biocompatible microenvironment for cell encapsulation and electronic stimulation.

FIG. 10A depicts the composition and deposition process. A deposition solution is prepared containing genetically engineered cells, thiolated PEG monomers (50 mg/mL), and a redox mediator, such as ferrocene dimethanol (5 mM). This solution is applied onto the working electrode 310, followed by the application of an oxidative potential between a first positive voltage and a second positive voltage. In the present embodiment, the oxidative potential is approximately +0.8 V. In alternative embodiments, the oxidative potential may range between +0.6 V and +1.0 V. During this process, the ferrocene mediator facilitates oxidation of the terminal thiol groups in the PEG chains, initiating the formation of disulfide crosslinks. This generates a hydrogel network localized on the electrode surface. Simultaneously, the engineered cells within the deposition solution are physically entrapped and immobilized within the forming hydrogel. The duration of voltage application (ranging from 10 to 600 seconds) may be used to control the density and distribution of immobilized cells. The electrochemical control signals used to initiate and modulate the deposition process are generated by the potentiostat board 253 under the control of the autonomous firmware executed by the microcontroller board 252 (see e.g., FIGS. 4-5), or by the float-type PCB unit 260 in alternative configurations (see FIG. 8). These control signals enable programmable and reproducible hydrogel assembly with minimal user input.

After deposition, the uncured solution is removed, and the gel is rinsed with phosphate-buffered saline (PBS) to ensure a clean surface and stable matrix. To activate the immobilized cells, FIG. 10B illustrates an electrogenetic induction mechanism. A reductive potential between a first negative voltage and a second negative voltage is applied to the working electrode 310, leading to the localized generation of hydrogen peroxide (H₂O₂) via reduction of molecular oxygen present in the culture media. In the present embodiment, the reductive potential is about −0.8 V. In alternative embodiments, the reductive potential may range between −0.6 V and −1.0 V. The immediate proximity of the immobilized cells to the electrode ensures rapid and spatially confined exposure to the electrogenerated signal, minimizing diffusion latency and facilitating fast cellular response, allowing for precise, time-controlled stimulation of engineered gene circuits using electrical inputs. This electrodeposition technique can be performed on a variety of electrode geometries and surface areas, supporting flexible integration into different device formats. The resulting hydrogel network enables the immobilized cells to act as both sensors and actuators, depending on the applied signal. In some embodiments, the entrapped cells contain programmable gene circuits responsive to specific electrical stimuli, enabling dynamic control over gene expression, biosynthesis, or cellular metabolism. This includes logic-driven gene toggling or electronic CRISPR-based actuation systems, allowing for closed-loop modulation of engineered biological processes.

This applied reductive potential constitutes the actuation signal, as defined in the present disclosure. It is generated by the potentiostat under firmware control in response to previously acquired electrochemical data, such as a detected oxidation peak or a baseline current crossing a predefined threshold. The firmware may map electrochemical signatures to predefined actuation protocols that are stored in memory, thereby enabling repeatable and context-specific biological stimulation.

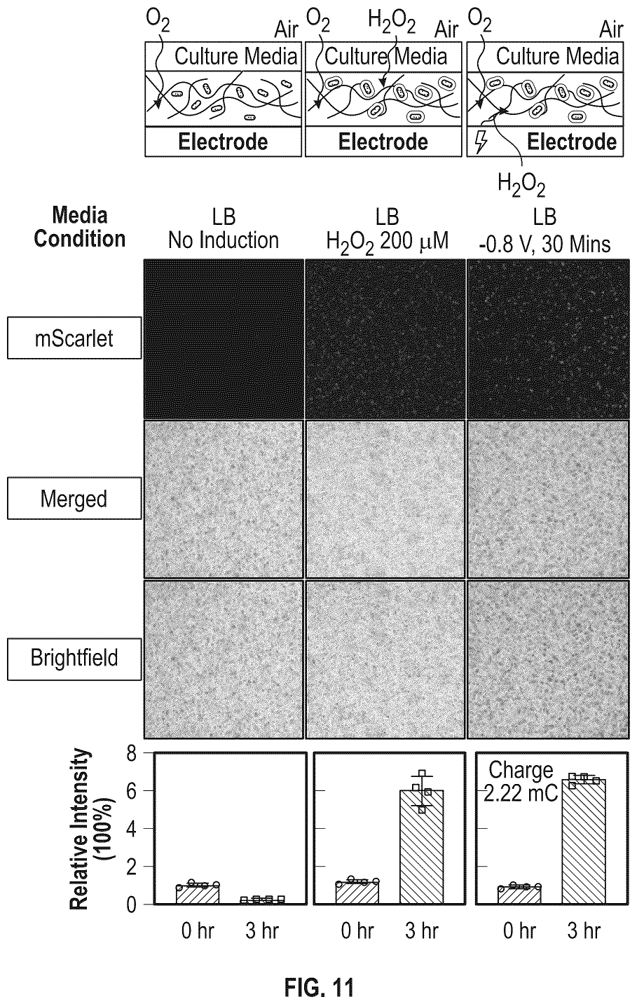

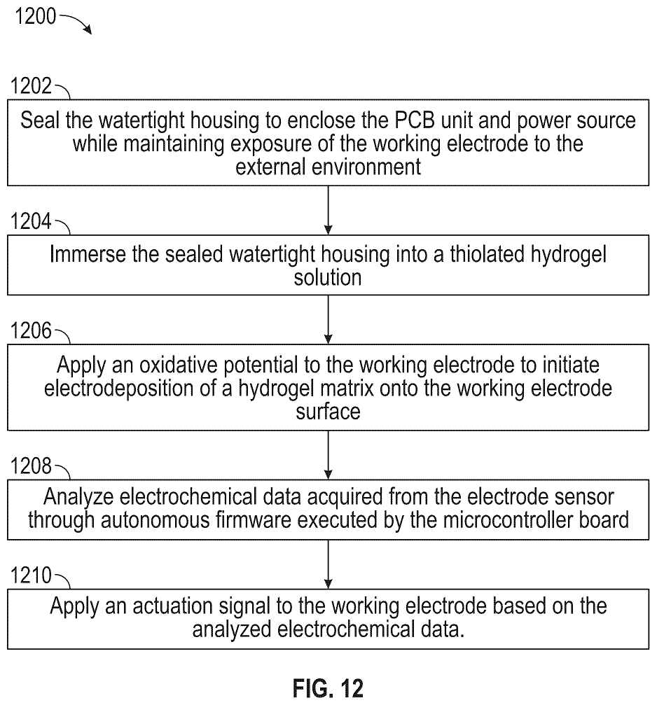

FIG. 11 demonstrates a representative example of this platform using a strain of engineered Escherichia coli (E. coli), designated MJC683. This strain contains a redox-responsive oxyRS regulon, which has been engineered to express the fluorescent protein mScarlet-I in response to intracellular H₂O₂ signals. FIG. 12 shows fluorescence imaging and corresponding intensity quantification under three different conditions: no induction (left column), chemical induction using 200 μM exogenous H₂O₂ (middle column), and electrogenetic induction using −0.8 V for 30 minutes (right column). In the absence of stimulation, mScarlet fluorescence was negligible. Upon both chemical and electrochemical induction, robust expression of mScarlet was observed after 3 hours of incubation. The experiment illustrated in FIG. 12 validates the capacity of the hydrogel-immobilized cells to respond selectively and efficiently to electrically delivered cues. The lower panels of FIG. 11 provide quantitative fluorescence data and electrochemical charge passed during stimulation (2.22 mC), confirming the correlation between electrical input and gene expression output.

FIG. 12 illustrates method 1200 for autonomous biological sensing and actuation using the biological sensing and actuation system 100. At step 1202, the watertight housing 400 is sealed to enclose the printed circuit board (PCB) unit 200 and power source (e.g., rechargeable battery 408), while maintaining exposure of the working electrode 310 of the electrode sensor 300 to the external environment. This configuration ensures environmental contact for sensing while protecting internal electronics.

At step 1204, the sealed watertight housing 400 is immersed into a thiolated hydrogel solution comprising thiolated polyethylene glycol (PEG-SH), a redox mediator such as ferrocene dimethanol, and genetically engineered cells.

At step 1206, an oxidative potential is applied to the working electrode 310 to initiate electrodeposition of a hydrogel matrix onto the exposed surface. This process results in disulfide crosslinking of PEG chains, encapsulating the engineered cells in a localized hydrogel coating on the electrode sensor 300. For example, an oxidative potential of approximately +0.8 V versus a silver/silver chloride reference electrode may be applied to the working electrode 310 for a duration between 30 and 300 seconds. This potential initiates oxidation of terminal thiol groups on polyethylene glycol (PEG-SH) chains present in the deposition solution leads to the formation of disulfide bonds that create a stable hydrogel network. Engineered cells suspended in the solution become physically entrapped within this forming matrix, resulting in a uniform and localized hydrogel coating on the electrode surface. The spatial confinement of the hydrogel on the electrode allows for precise positioning of the biological components and ensures effective electrical communication with the embedded cells for subsequent actuation.

At step 1208, electrochemical data is acquired from the electrode sensor 300 and analyzed in real time by autonomous firmware executed by the microcontroller board 252. For example, during a cyclic voltammetry (CV) routine, the potentiostat board 253 applies a voltage sweep to the working electrode while measuring the resulting current responses. These current signals are digitized and sent to the microcontroller board 252, where the autonomous firmware analyzes parameters such as peak current, baseline current, and peak position. If the firmware detects that a peak current exceeds a predefined threshold associated with a specific analyte concentration, such as the presence of a redox-active metabolite, it may classify the sample condition and log the event. The firmware may then trigger a corresponding actuation protocol, such as applying a reductive potential to initiate hydrogen peroxide generation. In some embodiments, the firmware compares real-time signal features against stored electrochemical profiles to select the appropriate stimulation parameters for downstream electrogenetic activation.

At step 1210, based on the analyzed electrochemical data, an actuation signal is applied to the working electrode 310. This signal may trigger the release of specific stimuli, such as hydrogen peroxide (H₂O₂), to activate electrogenetic responses in the encapsulated cells. The actuation signal may comprise a time-controlled reductive voltage selected from a predefined library of actuation profiles stored in the microcontroller memory. The selection of the actuation signal is based on a comparison of acquired voltametric or amperometric data to programmed thresholds or logic functions defined within the firmware.

The term “actuation signal,” as used herein, refers to an electrically generated voltage waveform or pulse applied to the working electrode to elicit a specific biological response from immobilized engineered cells. The characteristics of the actuation signal, including amplitude, polarity, duration, and waveform shape, are determined by the autonomous firmware based on thresholds or patterns identified in electrochemical data. For example, detection of a redox peak or concentration threshold may trigger the firmware to apply a reductive potential of about-0.8 V to generate hydrogen peroxide, which functions as an intracellular signal in the engineered cells.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A method for autonomous biological sensing and actuation, comprising:
placing a printed circuit board (PCB) unit comprising a power controller board, microcontroller board, a potentiostat board, and a power source, inside a watertight housing;
connecting an electrode sensor to the potentiostat board and securing the electrode sensor to the watertight housing, the electrode sensor comprising a working electrode configured to be exposed to an external environment;
sealing the watertight housing to enclose the PCB unit and power source while maintaining exposure of the working electrode to the external environment;
immersing the sealed watertight housing into a thiolated hydrogel solution;
applying an oxidative potential to the working electrode to initiate electrodeposition of a hydrogel matrix onto the working electrode surface;
analyzing electrochemical data acquired from the electrode sensor through autonomous firmware executed by the microcontroller board; and
applying an actuation signal to the working electrode based on the analyzed electrochemical data.

2. The method of claim 1, wherein the thiolated hydrogel solution comprises thiolated polyethylene glycol (PEG-SH) and a redox mediator selected from ferrocene, ferrocene dimethanol, or mixtures thereof.

3. The method of claim 1, further comprising entrapping genetically engineered cells within the hydrogel matrix formed on the working electrode.

4. The method of claim 1, wherein the oxidative potential applied to the working electrode is between a first positive voltage and a second positive voltage versus a silver/silver chloride reference electrode.

5. The method of claim 3, wherein a reductive potential is applied to the working electrode to generate hydrogen peroxide for triggering a biological response in the genetically engineered cells.

6. The method of claim 5, wherein the biological response comprises activation of an electrogenetic circuit configured to express a protein, signaling molecule, or metabolite.

7. The method of claim 1, wherein the autonomous firmware is configured to perform electrochemical measurements using one or more techniques selected from cyclic voltammetry (CV), chronoamperometry (CA), or differential pulse voltammetry (DPV).

8. The method of claim 7, wherein the autonomous firmware dynamically adjusts stimulation parameters based on real-time electrochemical signal analysis.

9. The method of claim 1, further comprising wirelessly transmitting electrochemical or actuation data to an external device via Bluetooth or sub-GHz radio communication.

10. The method of claim 1, wherein the watertight housing is configured as a float-type device having an antenna oriented above a liquid surface during operation.

11. The method of claim 1, wherein the watertight housing is configured as an immersion-type device adapted for free movement in stirred or confined liquid environments.

12. A system for biological sensing and actuation, comprising:
a potentiostat circuit configured to perform electrochemical measurements using an electrode sensor comprising a working electrode, a counter electrode, and a reference electrode;
a power controller configured to regulate power delivery to a processor and the potentiostat circuit, and to manage energy input from a wireless charging coil;
a processor; and
a memory, including instructions stored thereon, which when executed by the processor cause the system to:
apply an oxidative potential to the working electrode to deposit a hydrogel matrix on the electrode surface;
collect electrochemical measurements from the electrode sensor; and
apply an actuation signal to the electrode sensor based on the electrochemical measurements; and
a watertight housing configured to enclose the potentiostat circuit, power controller, processor, and memory, and to support coupling of the electrode sensor such that the working electrode remains exposed to the external environment.

13. The system of claim 12, wherein the hydrogel matrix comprises thiolated polyethylene glycol (PEG-SH).

14. The system of claim 12, wherein the hydrogel matrix includes genetically engineered cells.

15. The system of claim 14, wherein the genetically engineered cells are configured to respond to hydrogen peroxide (H₂O₂) as an electrogenetic trigger.

16. The system of claim 12, wherein the actuation signal comprises a reductive voltage applied to the working electrode to generate hydrogen peroxide in situ.

17. The system of claim 12, wherein the controller further comprises a wireless communication module configured to transmit electrochemical data via Bluetooth or sub-GHz radio frequencies.

18. The system of claim 12, wherein the watertight housing comprises:
a first screw-on cap having a plurality of integrated pockets configured to receive a plurality of weights; and
a second screw-on cap configured to engage with the first screw-on cap to secure the electrode sensor.

19. The system of claim 18, wherein placement of the plurality of weights is adjustable to control the flotation orientation of the watertight housing in a fluid environment.

20. The system of claim 12, wherein the electrode sensor is removably mounted to the watertight housing and electrically connected to the potentiostat via spring-loaded contacts.

21. The system of claim 12, wherein the system is configured to operate autonomously based on onboard firmware without continuous external control.
